(19) United States
(12) Patent Application Publication
(10) Pub. No.: US 2014/0156457 A1
(43) Pub. Date: Jun. 5, 2014

(54) METHODS AND ARRANGEMENTS FOR FACILITATING THE PROCESSING OF REAL ESTATE INFORMATION

(71) Applicant: Randall Hollister, Pittsburgh, PA (US)

(72) Inventor: Randall Hollister, Pittsburgh, PA (US)

(73) Assignee: REALOGY OPERATIONS LLC, Parsippany, NJ (US)

(21) Appl. No.: 14/030,800

(22) Filed: Sep. 18, 2013

Related U.S. Application Data
(63) Continuation of application No. 10/167,132, filed on Jun. 10, 2002, now abandoned.

(51) Int. Cl. G06Q 30/06; G06Q 50/16

(52) U.S. Cl. CPC G06Q 30/0613; G06Q 50/16
USPC 705/26.41

(57) ABSTRACT

An automated system that routes real estate leads, both from online sources and more traditional sources, to an agent who will be able to respond to the customer(s) associated with the lead in a very short time, perhaps a matter of minutes. A primary advantage associated with at least one embodiment of the present invention is that the response to real estate leads is shortened by a very large order of magnitude, as conventional response time may typically be in the range of several hours to several days.

### CROSS-REFERENCE TO RELATED APPLICATIONS

The present application is a continuation of U.S. patent application Ser. No. 10/167,132, filed Jun. 10, 2002, the disclosure of which is incorporated herein by reference.

### FIELD OF THE INVENTION

The present invention relates generally to systems in the field of real estate that can be of assistance in developing and closing real estate transactions.

### BACKGROUND OF THE INVENTION

Needs have long been recognized in the field of real estate in connection with the efficient processing of information related to real estate transactions. Computer-based tools have been evolving over the years with varying degrees of success. Particular needs have been recognized in connection with developing, tracking and processing real estate “leads”, or information related not only to potential buyers but also to sellers, renters, landlords and borrowers in conjunction with the sale, lease or financing of one or more properties. To date the conventional efforts have not generally resulted in the level of efficiency and versatility desired.

As but one example, Fidelity National Information Solutions (www.fnis.com) appears to provide a system, SureLead, that provides “automated assignment, reminder and follow up to any Internet generated lead.” However, there appears to be no suggestion that this arrangement can accommodate non-internet leads or positive lead delivery and acceptance. Positive lead delivery and acceptance preferably ensures that the lead has been actually received by a person and that person has accepted the lead. This differs, for example, from merely placing a message slip on a person's desk. In such a situation, it may not known whether the person is out of the office for an extended period of time and if so, the lead may languish.
a. In view of the foregoing, a need has been recognized in connection with overcoming the shortcomings and disadvantages presented by conventional arrangements.

### SUMMARY OF THE INVENTION

In accordance with at least one presently preferred embodiment of the present invention, there is broadly contemplated an automated system that routes real estate leads, both from online sources and more traditional sources, to an agent who will be able to respond to the customer(s) associated with the lead in a very short time, perhaps a matter of minutes. A primary advantage associated with at least one embodiment of the present invention is that the response to real estate leads is shortened by a very large order of magnitude, as conventional response time may typically be in the range of several hours to several days.

Also contemplated herein is the following-up of such leads, including the tracking of the progress of such leads through closing.

In summary, the present invention provides, in one aspect, a system for facilitating the propagation of information relating to a real estate transaction, the system comprising: an acceptor which accepts a real estate lead from either one of: an internet source or a non-internet source; a tagger and scorer which tags and scores the real estate lead; and a router which routes the real estate lead to a destination based on at least one criterion associated with the real estate lead.

In another aspect, the present invention provides a method of facilitating the propagation of information relating to a real estate transaction, the method comprising the steps of: accepting a real estate lead from either one of: an internet source or a non-internet source; tagging and scoring the real estate lead; and routing the real estate lead to a destination based on at least one criterion associated with the real estate lead.

Furthermore, the present invention provides, in an additional aspect, a program storage device readable by machine, tangibly embodying a program of instructions executable by the machine to perform method steps for facilitating the propagation of information relating to a real estate transaction, the method comprising the steps of: accepting a real estate lead from either one of: an internet source or a non-internet source; tagging and scoring the real estate lead; and routing the real estate lead to a destination based on at least one criterion associated with the real estate lead.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 is a block diagram of a process of lead entry, evaluation and scoring.

FIG. 2 is a block diagram of tagging, evaluating and scoring a lead.

FIG. 3 is a block diagram of a lead filtering process.

FIG. 4 is a block diagram of factors tracked in an agent's profile.

FIG. 5 is a block diagram of sorting and matching lead attributes to agents' profiles.

FIG. 6 is a block diagram of a lead routing process.

FIG. 7 is a block diagram of an agent accepting or rejecting a lead.

FIG. 8 is a block diagram of a lead follow-up process.

FIG. 9 is a block diagram of an agent working a lead.

### DESCRIPTION OF THE PREFERRED EMBODIMENTS

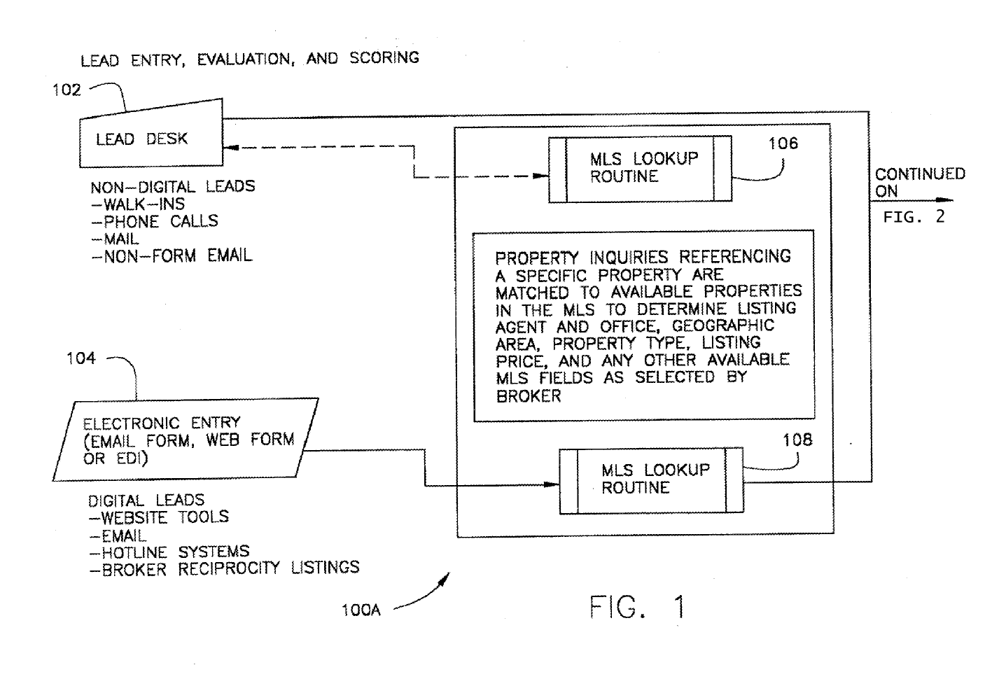

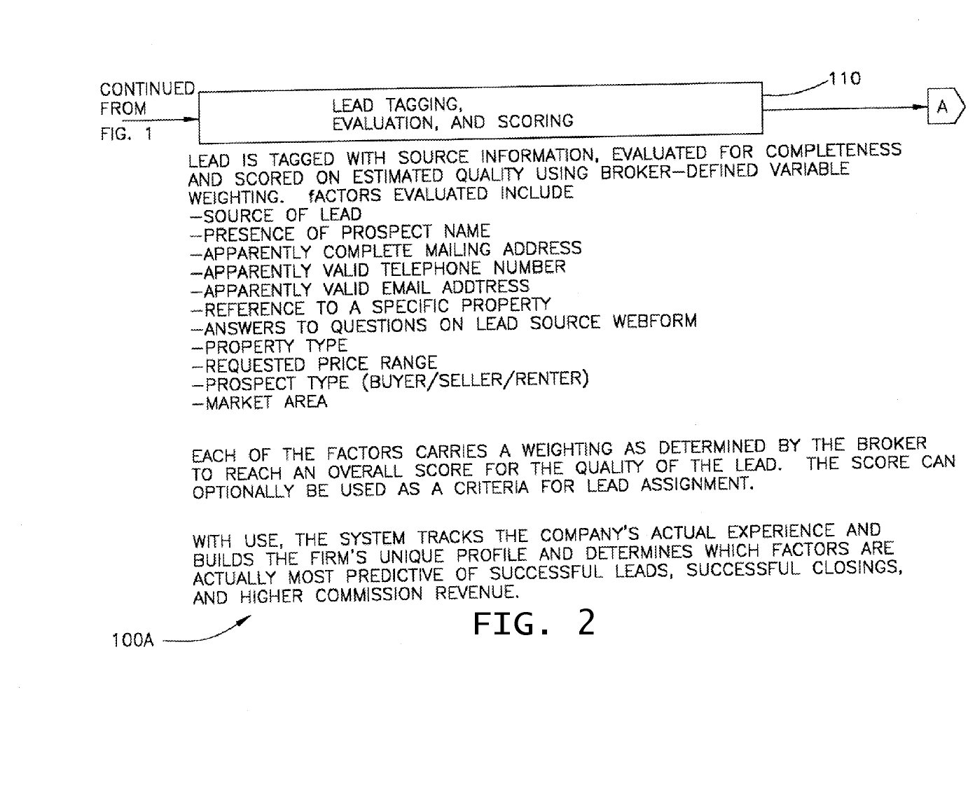

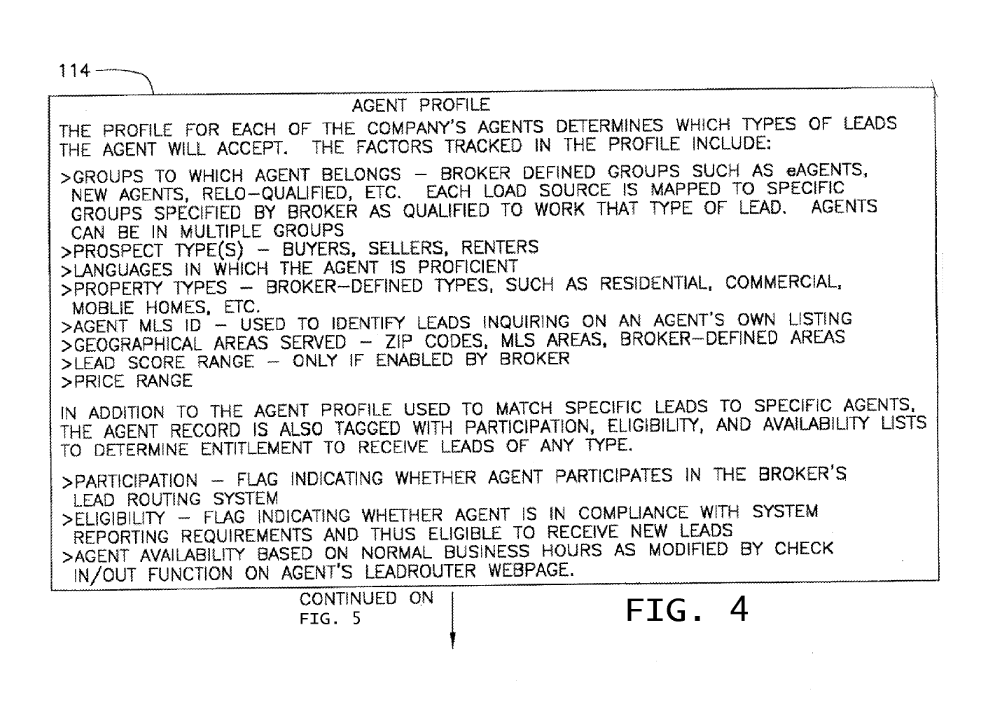

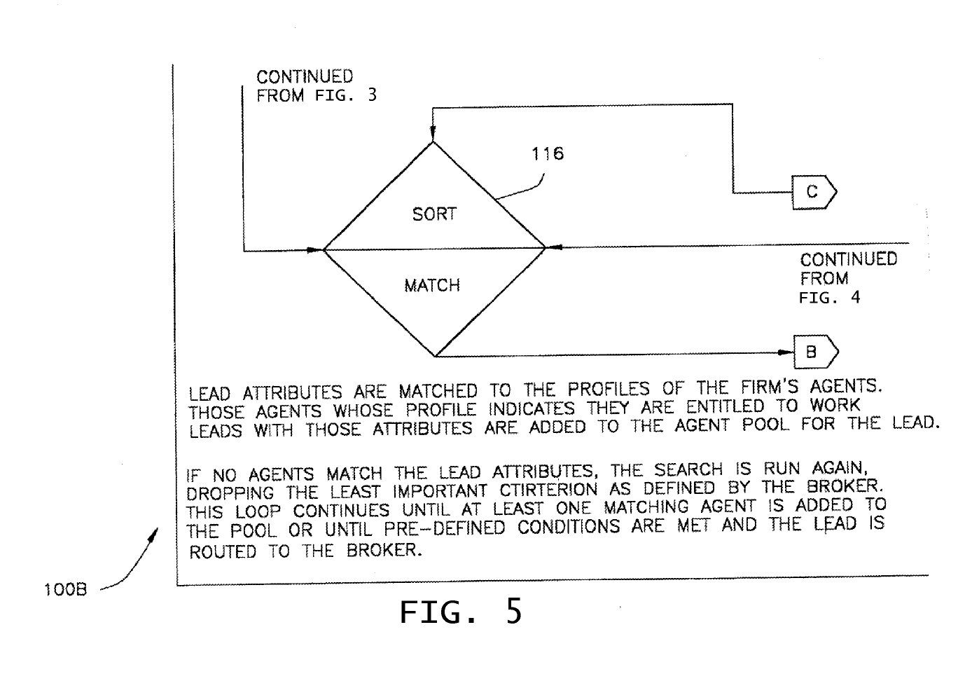

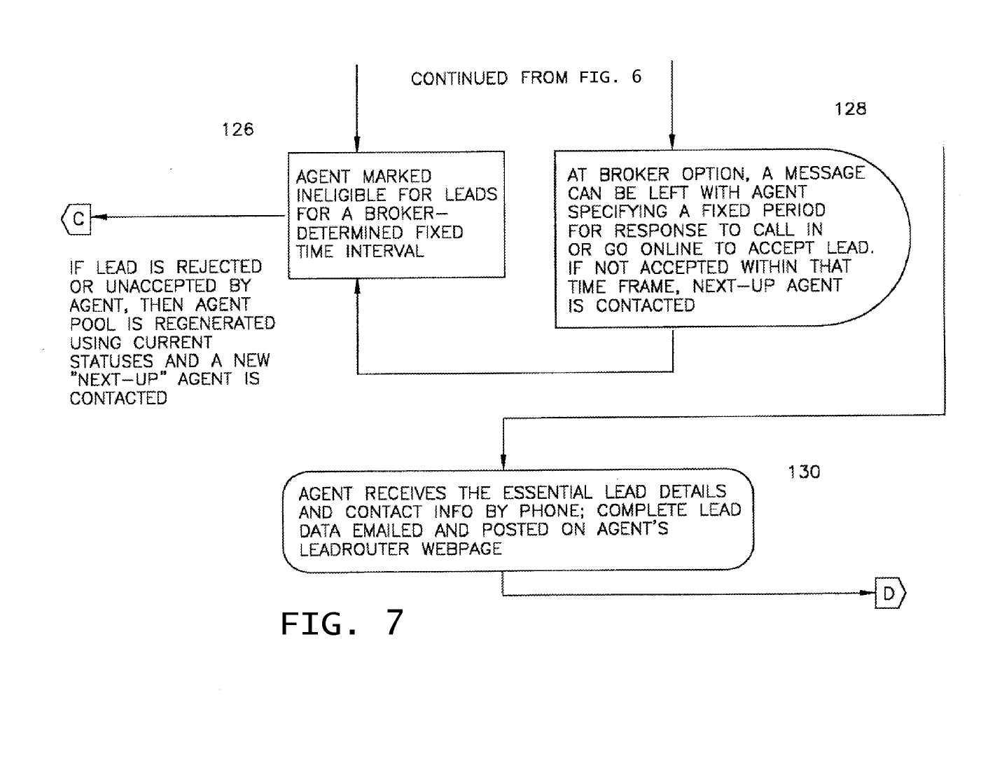

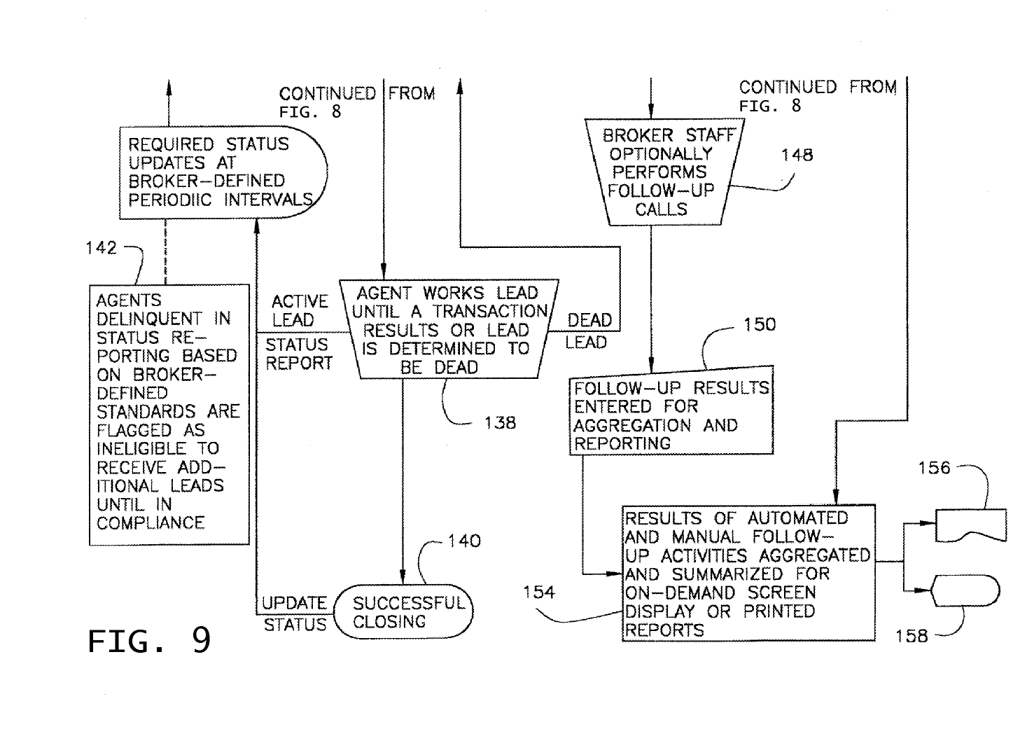

FIGS. 1-9 successively illustrate various subsidiary processes in a general lead-routing process in accordance with a preferred embodiment of the present invention. Such a process may be utilized, for example, by a broker who is designated to distribute lead information to different real estate agents. (A broker [e.g. a company or one or more individuals at a company] may frequently receive leads that are not directed to a specific agent. Those leads may then generally be distributed to various agents for handling.) It should be understood that the subsidiary processes shown are integrable with one another in a manner to be described below, so as to form a single extended process. However, it is conceivable to utilize any of the subsidiary processes (100a, 100b, 100c and 100d) below in isolation if it is only desired that the steps associated with a subsidiary process be utilized apart from other conceivable process steps, to fulfill a predetermined purpose associated solely with one of the subsidiary processes.

FIG. 1 is a block diagram of a process of lead entry, evaluation and scoring. As shown, this process 100a may preferably initiate either at a “lead desk” 102, or with the electronic entry of leads (104), or both. Lead desk 102 is associated with more traditional methods of obtaining real estate leads, e.g. via walk-ins, phone calls, surface mail and/or non-form email (e.g., a free-form email inquiry message). In this case, the agent at lead desk 102 will enter information into the lead processing system (e.g. a web-based application system). On the other hand, electronic entry (104) may be achieved via the receipt of emails, via a website, or via Electronic Data Interchange (EDI). Preferably, XML may also be supportable for lead entry, including much of that system's internal communications (such as with an IVR service provider).

(Entry via emails may be automatic if there is a capability of identifying the source of an email. In this vein, a unique email address can be identified for each source, whereby any messages sent to that address can be parsed and automatically routed. If sufficient routing information is not available, the message can be sent to the broker for manual processing through the lead desk.) Leads may also come in via hotline systems and broker reciprocity listings. (Hotline systems are systems which typically use a yard sign in front of a property with a phone number and a property reference code. The consumer hears information about the property while their caller ID info is sent to the agent via pager.) Generally brokers only make their own listings available on their web sites. Broker reciprocity is a term to describe the situation when one broker's listings are displayed on another broker's web site.

In either instance, a corresponding Multiple Listing Service (MLS) lookup routine (106, 108) may be performed such that, preferably, property inquiries referencing a specific property are matched to available properties in the MLS to determine the agent who listed the property, his or her office, the geographic area of the property, property type, listing price and any other predetermined MLS fields. (Preferably, the MLS lookup routine here involves a lookup screen which may be, e.g., an optional popup window in a web-based application system. As an example of use, in the process of talking with a prospect on the phone, e.g., a real estate associate may fill in the web-based form with the prospect's interests. If the customer mentions a property address, the MLS lookup allows the associate to populate all of the appropriate fields in the form. If no specific property is mentioned, the system can route based on a geographic area or even to a group of agents willing to accept leads for an unknown area within the marketplace.) Electronic leads are all preferably matched to the MLS database. If the lead has reference to a specific property (listing number or address), then all appropriate fields (listing number, address, geographic area, listing agent, price, etc.) are preferably automatically populated and used to properly route the lead.

The next step in the process (110) preferably involves lead “tagging”, evaluation and scoring. Preferably, the lead will be “tagged” with (i.e., associated with data relating to) the source information derived from the MLS lookup routine (106/108), evaluated for completeness and scored with regard to its estimated quality. Scoring is preferably achieved, through the use of variable weighting predetermined by the broker and the subsequent determination of a numerical score. This score could also be used as a criterion for assigning the lead.

Evaluation could involve assessing: the source of the lead; whether or not there is a name for the “prospect”; whether or not there is an apparently complete mailing address, valid telephone number and/or email address; whether there is reference to a specific property; whether questions, e.g., which may have been provided at a website, have been answered; the type of property; a price range requested by the prospect; the type of prospect (e.g., buyer, seller or renter); and the market area.

Another factor that can be employed in determining “lead quality” is whether the prospect has asked for help of simply indicated an interest in real estate. For example, identifying a prospective buyer by using caller ID of a hotline call will essentially only indicated that there is some general interest in real estate. But if such a person were to affirmatively ask to be connected to an agent, then a much higher “quality” lead would be present. Thus, in a preferred embodiment of the present invention, all leads will also be tagged with such factors for routing. Some agents may wish to be considered only for the latter type, while others may well wish to accept either type.

Depending on the needs at hand, any of the entry fields could be required to be filled for further processing (e.g., those minimally necessary for routing the lead, such as the source and a contact phone number or email), while others could be merely optional. It will be appreciated that, as the system is used more and more, an archive of the company's experience can be developed in such a way as to provide a basis for predicting, in connection with future leads, which leads may be successful (e.g. which leads may be indicative of a strong likelihood of a successful closing and/or of higher commission revenue).

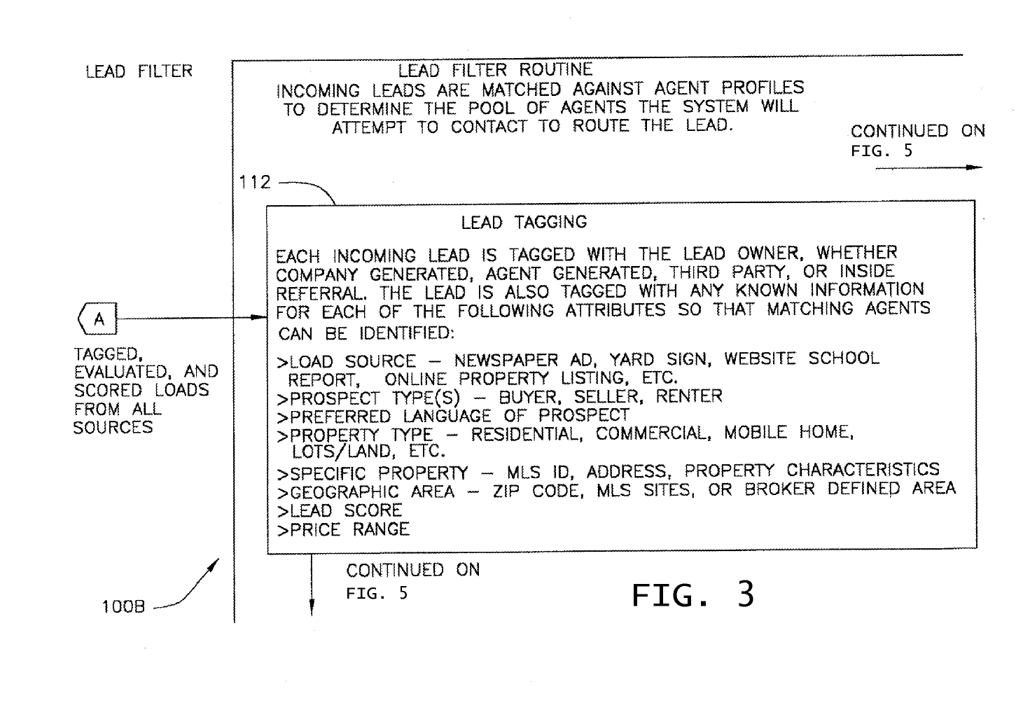

Block A, as shown, indicates that the process may then progress to a lead filtering process as shown in FIG. 3. In this process 100b, tagged, evaluated and scored leads from different sources (at A) preferably end up being matched against profiles of real estate agents to determine the pool of agents that the system will attempt to contact in further routing the lead. At 112, each incoming lead is preferably tagged with the owner of the lead, with information as to whether the lead was generated by the company, by an agent, by a third party or by inside referral, and also with any known information for a number of attributes, e.g., the lead source (e.g., newspaper ad, yard sign, website report on local schools, online property listing), the prospect type (e.g., buyer, seller, renter), the prospect's preferred language of discourse, the property type (e.g., residential, commercial, mobile home, lots/land, etc.), the specific property (e.g., MLS ID no., address, any property characteristics), geographic area (e.g., zip code, MLS area or an area defined by the broker), the lead score, and a price range.

As far as “owning” a lead goes, it is typically the case that he/she who pays to generate the lead “owns” the lead. For example, an agent who buys an ad in the newspaper typically gets all leads from that ad without paying a referral fee to the broker. If the broker generates the lead through his marketing activities, he/she frequently charges the agent a referral fee (like 25-30% of the commission). Tagging sets that “ownership” at the beginning of the lead so it isn't forgotten or is a matter of a dispute months later when the deal closes, as is a common occurrence today.

“Inside referral” refers to a situation where a busy agent may have more leads than he/she can personally follow-up on. It is thus not uncommon for he/she to refer the surplus off to other, less busy agents for a portion of the commission (typically in the 20-30% range). This system allows those internal referrals to be routed in the same way company leads are, and tagging the lead as “owned” by the referring agent.

Tagged leads will preferably be matched with agent profiles (114). Preferably, a profile for each of the company's agents will determine the types of leads that the agent will accept. The factors tracked in such a profile may include, but are by no means limited to:

groups to which the agent belongs (e.g. eAgents, new agents, relocation-qualified agents, etc.) eAgents are preferably agents designated to deal with leads generated by electronic means; relocation agents are preferably agents designated to deal with relocations. Each lead source may preferably be mapped to groups specified by the broker as being qualified to work that type of lead; an agent could certainly be in more than one such group;

prospect types associated with the agent;

any languages in which the agent is proficient;

property types associated with the agent;

the agent's MLS ID no. (which could be used to identify leads inquiring on an agent's own listing);

geographic area served;

a range of lead scores possibly associated with the agent (if so defined by the broker); and

price range.

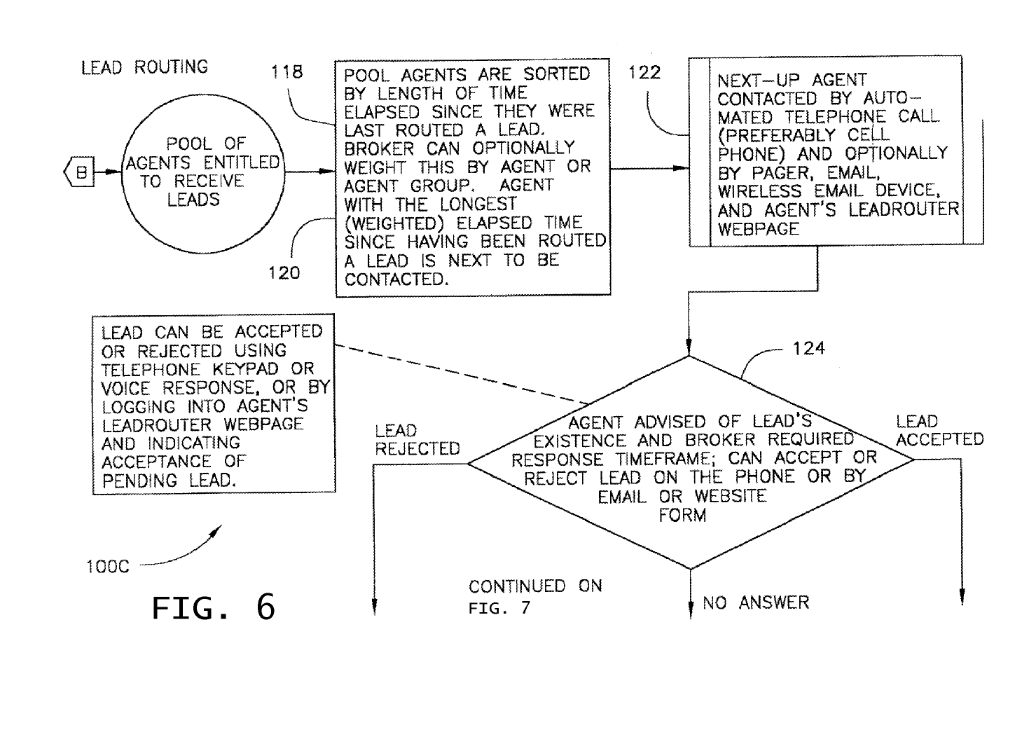

In addition to the agent profile used to match specific leads to specific agents, the agent record may also be tagged with data relating to participation, eligibility and availability to determine whether he/she is entitled to receive leads of any type. For instance, a participation flag may indicate whether the agent even participates in the broker's lead routing system to begin with. An eligibility flag could indicate whether the agent is in compliance with any system reporting requirements and, thus, eligible to receive new leads. Availability data could relate to the agent's normal business hours, possibly modified by a check in/check out function on, e.g., a webpage when an agent logs in or out on a typical day. At sorting and matching step 116, lead attributes may preferably be matched to profiles of different agents. An agent pool is preferably developed for a given lead whereby any agent whose profile indicates that he/she is entitled to generally work leads with the attributes of the given lead can be added to the pool of possible contacts for the lead. If no agents match the lead attributes, the search may preferably be run again, dropping perhaps a “least important” criterion as defined by the broker. Such a loop may preferably continue until at least one matching agent is added to the pool or until pre-defined conditions are met and the lead is routed not to an agent but to the broker. In this manner, there is always some assurance that essentially any lead will quickly and efficiently be routed to some individual. These routing steps may be better appreciated from reference to FIG. 6 and the corresponding discussion herebelow.

Block B, as shown, indicates that the process may then progress to a lead routing process as shown in FIG. 6. In this process 100c, the aforementioned agent pool (118) may then be sorted (at 120) by the length of time elapsed since each was last routed a lead. The broker would optionally weight this time factor with respect to individual agents or agent groups, based on essentially any predetermined criteria. The agent from the pool having the longest (possibly weighted) elapsed time since a previously routed lead is thence designated as being the next agent to be contacted.

Preferably, at 122, this “next-up” agent may be contacted by an automated telephone call, e.g. to his/her cell phone, or in some other manner, e.g. pager, email, email device, or at his/her personal webpage (as discussed previously).

At 124, in being advised of the lead's existence and of, e.g., a response time frame requested or required by the broker, the agent may thence accept or reject the lead. The lead could be accepted or rejected, e.g., by using a telephone keypad or voice response, or by logging into the agent's personal webpage and indicating acceptance there.

Should the agent expressly reject the lead, then at 126 the agent may preferably be marked as “ineligible” for further leads for a predetermined time interval (e.g. as defined by the broker). If, on the other hand, the agent does not response to the aforementioned contact, then at 128 a message could possibly (perhaps at the broker's option) be left with the agent specifying a fixed period of time during which to respond (e.g. via calling in or via a webpage) with acceptance. The process may then revert to step 126 as shown if no acceptance is forthcoming during the defined time interval.

After being marked for “ineligibility” (at 126), then, as shown via C in FIGS. 6 and 3, the process preferably reverts to step 116 (FIG. 3) in order that the agent pool may be regenerated with a view to contacting a new “next-up” agent.

If, at step 124, the agent accepts the proffered lead, then at 130 the agent will receive (e.g., via phone) any lead details deemed essential, and any needed contact information. (This may preferably be an automatic process; once an agent has indicated acceptance of a proffered lead [by voice or keypad] he/she may, e.g., receive the information over the phone by a combination of recorded voice and text-to-speech [TTS].) Further, complete data relating to the lead could be emailed to and posted on the agent's personal web page (if any).

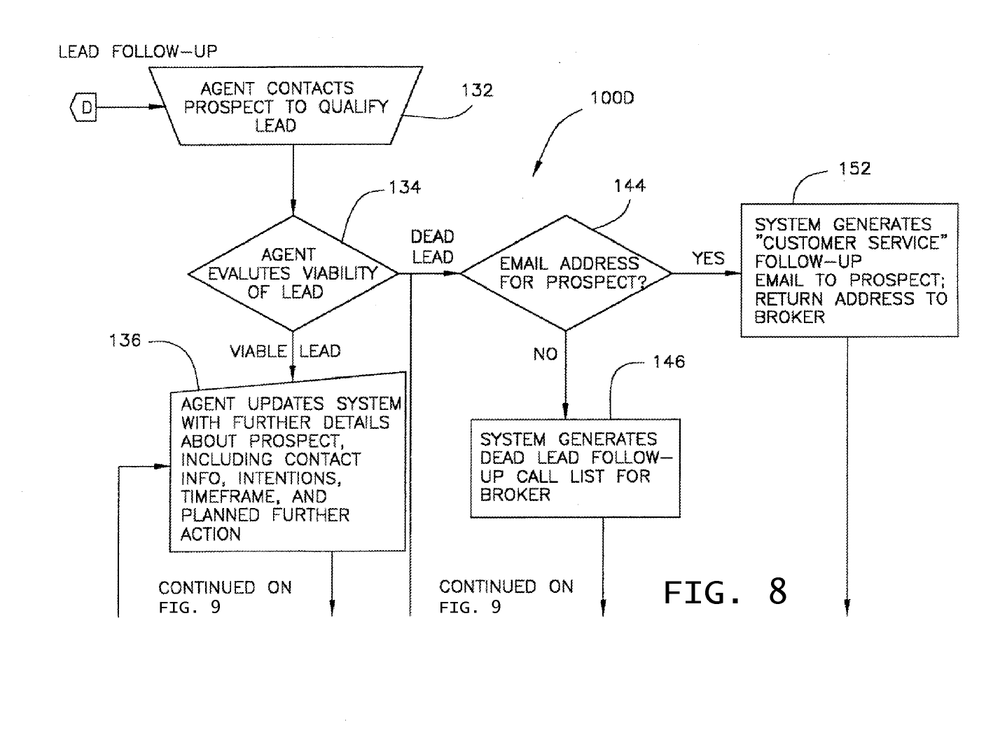

Block D, as shown, indicates that the process may then progress to a lead follow-up process as shown in FIG. 8. In this process 100d, the agent first preferably contacts the prospect (132) then, at 134, evaluates the viability of the lead. If deemed to be a viable lead, then at 136 the agent may preferably update the system with further details regarding the prospect, such as contact information, the prospect's intentions, a timeframe for interacting with the prospect, and any information related to possible further action. The agent will preferably “work the lead” (i.e., interact with the prospect in connection with the lead) (138) until a transaction results or the lead is determined to be dead (i.e., a lead with no further contemplated actions; the customer may have already purchased from someone else, lost interest, not responded to contacts, etc.) At this stage, the agent may opt to enter an “active lead status report” or “work the lead” towards a successful closing (140). In either eventuality, the agent will preferably provide a status update at 142, which may take place at intervals predetermined by the broker. Possibly, agents delinquent in undertaking such status reporting may be flagged as “ineligible” to receive additional leads until they are back in compliance with such reporting. The process then resumes at 136. If there is a successful closing, the process essentially ends at this point. However, the contact involved may preferably remain in the database, e.g., for use in future marketing. If, at 134, the agent determines the lead to be “dead”, then at 144 it will be ascertained as to whether there is an email address associated with the prospect. If no, then at 146 the system may preferably generate a dead lead follow-up call list for the broker, whereby at 148 the broker or the broker's staff could optionally perform such follow-up calls, and then at 150 any follow-up results could be entered for aggregation “Aggregation” and “reporting” may preferably tracking the result of every lead entered into the system whereby, over time, the broker will be able to see what sources are more effective than others or result in more closings or higher commissions. The broker will then conceivably be able to evaluate sources, groups, offices, market areas, etc. to assist in building more effective future marketing campaigns.

If, however, it is indeed determined that an email address exists, then at 152 the system may preferably generate a “customer service follow up” email to the prospect, with the broker's email address preferably used as a return address. Such an email may involve, e.g., an invitation for the recipient to return with additional questions, etc., to ensure that the recipient was indeed reached at some point and, perhaps, to determine whether an opportunity exists to resuscitate a “dead lead”.

Preferably, steps 150 and 152 will each be followed by step 154, whereby results of automated and/or manual follow-up activities will be aggregated and/or summarized for on-demand screen display or for printed reports.

Indicated at 156 and 158, respectively, are on-screen output and printed output, either or both of which may preferably be employed here.

From the foregoing, it will be appreciated that several unique features and associated advantages may be achievable with a system according to at least one embodiment of the present invention, as follows:

leads can be routed from both traditional sources and online sources;

leads are automatically reassigned to real estate agents based on some or all of the following characteristics:

availability (e.g. the agent can specify his/her normal business hours for accepting leads);

source of the lead (i.e., since leads are tagged as to the ownership of the lead and the media source of the lead, the broker can designate certain groups of agents to receive leads from certain sources);

qualification (e.g., there may be a virtually unlimited number of qualifications definable by the broker for leads based on the source, such as “eLeads” (i.e., electronically generated leads, such as from a website) or relocation leads being routed only to agents qualified to handle them (especially if formal designation for any such leads is required), or leads from a given marketing campaign being routed only to agents participating in the cost of that campaign, or leads being routed to a “new agent” group in heightened proportions as part of a recruiting bonus);

geographic area served (e.g. leads could be routed only to agents serving a particular market sub-area determined by the broker);

property type;

prospect type;

eligibility (e.g., agents who are not in compliance with the broker's lead follow-up rules could be made ineligible for additional leads until they return to compliance, or an eligibility “flag” could be manually set or cleared by the broker);

foreign language proficiency (e.g., agents proficient in given languages may receive leads designated for such a capability; automated assignment from a foreign language media source [e.g. a Spanish language website] could be directed solely to agents fluent in that language); and

weighted turn (e.g., once the list of potential referees is created, the system may allocate to the next “in turn” based on the time elapsed since that agent's last lead; the broker could optionally add weighting to different lead sources to alter this succession as needed or desired);

agents can be notified of new leads via automated telephone calls (among other methods);

positive lead assignment and acceptance can be employed, such that agents may only be presented with lead details if only they first affirmatively accept the lead, committing to the broker's service standards;

assigned leads may be automatically tracked for agent follow-up, while the broker may be prompted for attention to leads on which no action has been taken; if email is available, the customer could be automatically contacted in connection with a customer satisfaction survey at predetermined intervals (e.g. 24 hours); and

broker reciprocity lead routing is possible.

An advantageous refinement of the present invention may involve the capability to route leads to a broker's affiliates, e.g., to a captive mortgage company. Thusly, a broker may set up an essentially unlimited number of affiliates to which leads can be routed in the same manner as agent-routed leads. In this vein, an optional “lag time” may be built in such that a broker could give a real estate agent a head start (2 hours or 2 days, for example) before the lead is given to a mortgage representative. The routing options for mortgage affiliates (or other affiliates) will preferably work in the same manner as with real estate leads, with tests to determine which representative gets the lead, what the follow-up requirements are, etc.

Also broadly contemplated in accordance with at least one presently preferred embodiment of the present invention is an additional feature. Generally, it should be recognized that two of the traditional sources of new listings for real estate companies involve the pursuit of homes being offered “for-sale-by-owner” (known in the trade as “FSBO” and pronounced “Fizz-Bo”) as well as the pursuit of other firms' unsold listings upon the expiration of their listing agreements. Agents are often reluctant to pursue these sources despite the fact that the sellers clearly have a desire to sell their properties, and this often presents a source of great frustration to brokers. But it is recognized that some agents who work such sources indeed do so with great success.

Consequently, the present invention, in accordance with at least one presently preferred embodiment, offers an excellent tool for brokers to “push” these types of qualified leads to agents who will pursue them. For instance, a broker might instruct an administrative assistant go through a newspaper and enter each of the FSBOs into the system for routing to an agent who is willing and available to work that type of lead. The same could hold true for listings reported each day by the MLS as “expired”. To facilitate this, previously entered FSBO's could be tracked so that duplicates can be culled, since one property may be repeatedly advertised. When the FSBO is entered through the lead desk, the program could look for a match in any of the contact phone, contact email, or property address fields for a match to prevent duplicate assignment. This will thus allow brokers to better capture FSBOs and expireds. We believe it to be unique and would like to extend the patent protection to include this functionality.

It is to be understood that the present invention, in accordance with at least one presently preferred embodiment, includes an acceptor which accepts a real estate lead from either one of: an internet source or a non-internet source, a tagger and scorer which tags and scores the real estate lead, and a router which routes the real estate lead to a destination based on at least one criterion associated with the real estate lead. Together, the acceptor, tagger and scorer, and router may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. (canceled)

2. A method for routing real estate leads to real estate agents, the method comprising:
receiving, with one or more processors, a real estate lead associated with a real estate property, the real estate lead comprising a plurality of real estate lead attributes;
comparing, with the one or more processors, a plurality of search criterion with a plurality of real estate agent profiles, where each profile is associated with a real estate agent and a search criterion is associated with a real estate lead attribute selected from the plurality of real estate lead attributes;
determining, with the one or more processors, whether any real estate agents from the plurality of real estate agents are a match for the real estate lead based on the comparison;
when the number of determined matches is below a threshold number:
modifying, with the one or more processors, one or more of the search criterion; and
comparing, with the one or more processors, the modified search criterion with a plurality of real estate agent profiles to determine whether any real estate agents are a match for the lead, and repeating such modification and comparison until the number of determined matches is equal to or greater than the threshold number; and
when the number of determined matches is equal to or greater than the threshold number:
routing, with the one or more processors, the real estate lead to a real estate agent selected from the plurality of real estate agents.

3. The method of claim 1, wherein the real estate lead attributes comprise one or more of: an owner of the real estate lead, a lead source, a prospect type, a preferred language, a property type, a specific property, a geographic area, a lead score, and a price range.

4. The method of claim 1, wherein a given real estate agent profile associated with a given real estate agent comprises one or more of: one or more prospect types, one or more proficient languages, one or more property types, a geographic area served, a range of lead scores, and a price range.

5. The method of claim 1, wherein the threshold number of real estate agents is one.

6. The method of claim 1, wherein modifying the one or more search criterion comprises removing the one or more search criterion from being used in the comparison with the plurality of real estate agent profiles.

7. The method of claim 6, wherein the predetermined search condition comprises a ranking of importance of the one or more real estate lead attributes.

8. The method of claim 1, wherein the method further comprises determining whether a given real estate agent is eligible to be matched with the real estate lead; and
wherein the comparing of the plurality of search criterion with the real estate agent profile associated with the given real estate agent is based on the given real estate agent being eligible.

9. The method of claim 8, wherein determining whether the given real estate agent is eligible is based on whether the given real estate agent is in compliance with one or more reporting requirements.

10. The method of claim 1, further comprising:
identifying the real estate agent that received the routed real estate lead as being ineligible to receive additional real estate leads based on the real estate agent having rejected the routed real estate lead.

11. The method of claim 1, wherein the real estate lead is routed to an entity other than the plurality of real estate agents when there are no further modifications to be made to the one or more search criterion.

12. A system for routing real estate leads to real estate agents, the system comprising:
a non-transitory, computer-readable medium storing computer-executable instructions; and
one or more processors in communication with the non-transitory, computer-readable medium that, when the computer-executable instructions are executed, are configured to:
receive a real estate lead associated with a real estate property, the real estate lead comprising a plurality of real estate lead attributes;
compare a plurality of search criterion with a plurality of real estate agent profiles, where each profile is associated with a real estate agent and a search criterion is associated with a real estate lead attribute selected from the plurality of real estate lead attributes;
determine whether any real estate agents from the plurality of real estate agents are a match for the real estate lead based on the comparison;
when the number of determined matches is below a threshold number:
modify one or more of the search criterion; and
compare the modified search criterion with a plurality of real estate agent profiles to determine whether any real estate agents are a match for the lead, and repeating such modification and comparison until the number of determined matches is equal to or greater than the threshold number; and
when the number of determined matches is equal to or greater than the threshold number:
route the real estate lead to a real estate agent selected from the plurality of real estate agents.

13. The system of claim 12, wherein the real estate lead attributes comprise one or more of: an owner of the real estate lead, a lead source, a prospect type, a preferred language, a property type, a specific property, a geographic area, a lead score, and a price range.

14. The system of claim 12, wherein a given real estate agent profile associated with a given real estate agent comprises one or more of: one or more prospect types, one or more proficient languages, one or more property types, a geographic area served, a range of lead scores, and a price range.

15. The system of claim 12, wherein the one or more processors are further configured to:
determine whether a given real estate agent is eligible to be matched with the real estate lead; and
wherein the comparing of the plurality of search criterion with the real estate agent profile associated with the given real estate agent is based on the given real estate agent being eligible.

16. The system of claim 15, wherein the one or more processors are further configured to determine whether the given real estate agent is eligible is based on whether the given real estate agent is in compliance with one or more reporting requirements.

17. The system of claim 12, wherein the one or more processors are further configured to:
identify the real estate agent that received the routed real estate lead as being ineligible to receive additional real estate leads based on the real estate agent having rejected the routed real estate lead.

18. A non-transitory, computer-readable medium having computer-executable instructions stored thereon that, when executed by one or more processors, cause the one or more processors to perform a method, the method comprising:
receiving, with the one or more processors, a real estate lead associated with a real estate property, the real estate lead comprising a plurality of real estate lead attributes;
comparing, with the one or more processors, a plurality of search criterion with a plurality of real estate agent profiles, where each profile is associated with a real estate agent and a search criterion is associated with a real estate lead attribute selected from the plurality of real estate lead attributes;
determining, with the one or more processors, whether any real estate agents from the plurality of real estate agents are a match for the real estate lead based on the comparison;
when the number of determined matches is below a threshold number:
modifying, with the one or more processors, one or more of the search criterion; and
comparing, with the one or more processors, the modified search criterion with a plurality of real estate agent profiles to determine whether any real estate agents are a match for the lead, and repeating such modification and comparison until the number of determined matches is equal to or greater than the threshold number; and
when the number of determined matches is equal to or greater than the threshold number:
routing, with the one or more processors, the real estate lead to a real estate agent selected from the plurality of real estate agents.

19. The non-transitory, computer-readable medium of claim 18, wherein the real estate lead attributes comprise one or more of: an owner of the real estate lead, a lead source, a prospect type, a preferred language, a property type, a specific property, a geographic area, a lead score, and a price range.

20. The non-transitory, computer-readable medium of claim 18, wherein a given real estate agent profile associated with a given real estate agent comprises one or more of: one or more prospect types, one or more proficient languages, one or more property types, a geographic area served, a range of lead scores, and a price range.

21. The non-transitory, computer-readable medium of claim 18, wherein the method further comprises:
determining, with the one or more processors, whether a given real estate agent is eligible to be matched with the real estate lead; and
wherein the comparing of the plurality of search criterion with the real estate agent profile associated with the given real estate agent is based on the given real estate agent being eligible.
